(19) United States
(12) Patent Application Publication
(10) Pub. No.: US 2023/0237570 A1
(43) Pub. Date: Jul. 27, 2023

(54) CONTRACT ANALYSIS AND GENERATION METHOD AND SYSTEM

(71) Applicants: Zhi Li, Atlanta, GA (US); Thomas Lummis, Atlanta, GA (US)

(72) Inventors: Zhi Li, Atlanta, GA (US); Thomas Lummis, Atlanta, GA (US)

(21) Appl. No.: 17/576,937

(22) Filed: Jan. 27, 2022

(51) Int. Cl. G06Q 40/02; G06F 21/64; G06N 20/00

(52) U.S. Cl. CPC G06Q 40/025; G06F 21/64; G06N 20/00

(57) ABSTRACT

A contract analysis and generation method and system is provided. The method comprises a sequential flow of one or more events resulting in contract analysis and single-click contract generation. The system comprises a plurality of machine learning, natural language processing, and artificial intelligence based modules located on one or more devices or servers, wherein users may interact with the system via user devices.

### FIELD OF THE INVENTION

This invention relates to data processing and in particular to the analysis and generation of contracts.

### BACKGROUND OF THE INVENTION

Contracts provide the legal framework for conducting business. Many businesses today, particularly large corporations, are party to hundreds, perhaps thousands, of complex contracts. Many such contracts regularly span hundreds or thousands of pages in length. By definition, each contract grants various rights and creates various obligations. Keeping track of the mere existence of every contract and ensuring compliance with the various rights and obligations they create presents an enormous challenge for business entities and their employees.

Other problems arise during the processes of contract drafting and contract term negotiation. Even simple contracts often go through a number of drafts before a final agreement is reached. The contract negotiation process is typically complex as it is difficult to efficiently keep track of various contract clauses, contract versions, and approvals of various contract versions by the relevant parties.

Computer systems, networks, and databases have been created to meet some of these challenges. Specifically for the purposes of contract template generation, many such systems currently on the market operate as follows: a user copies and pastes, or uploads, a contract template to a contract generation website. To generate a list of necessary contract clauses, the website requires manual keyword parsing by the user or automatically parses for keywords itself based on the website's own fixed keywords. This process is unintuitive to lawyers and business practitioners, resulting in unnecessary workload as generated contracts simply do not achieve their desired purpose and require a significant amount of manual correction after generation.

During the aforementioned process, parsed keywords are often limited to standardized keywords such as the basic information of both parties, as well as the starting and ending dates of a contract. As a result, creating highly customized contracts using current technologies is difficult. When a contract template is used to generate a contract, users must still fill in contract clauses one at a time on the system web page. Furthermore, users are required to parse the entirety of the contract's content during future execution and query processes because key information is not parsed systematically. Thus, the process of generating a contract template and then generating a final version of a contract based on the contract template currently available on the market does not save time and effort when compared with the traditional method of drafting contracts using standard word processing software such as Microsoft Word.

### SUMMARY OF THE INVENTION

The present invention overcomes these drawbacks by using a contract analysis and generation process and system which functions, generally, as follow: Natural language processing (“NLP”) and artificial intelligence (“AI”) are used to transform relevant business files with text into question lists and contract templates. These generated question lists and contract templates may then be used by business negotiators to efficiently and effectively discuss key contract points during offline negotiations. Offline negotiations may optionally be guided by a machine learning data analysis module that offers negotiators insights into previous contracts which used the same or similar contract templates. Once offline negotiations are complete and, as a result, a question list has been filled in, the filled-in question list merely has to be uploaded to the system before the desired contract may be generated with just a single click. Some embodiments of the present invention will utilize the step of accessing and utilizing stored party information and stored contract lifecycle information during the contract analysis and generation process.

In one embodiment, a method for contract analysis and generation comprises processing a file resulting in a processed file, parsing keywords from said processed file resulting in a plurality of parsed keywords, generating a question list based on the parsed keywords, generating a contract based on a previously created contract template and said question list, approving and signing of said contract by all relevant parties resulting in a signed contract, and uploading said signed contract to the machine learning and data analysis module for archiving and future model training purposes.

In another embodiment, a method for contract analysis and generation comprises processing a file resulting in a processed file, parsing keywords from the processed file resulting in a plurality of keywords, generating a question list based on the parsed keywords, generating a contract based on a previously created contract template and said question list, approving and signing of said contract by all relevant parties resulting in a signed contract, uploading said signed contract to the machine learning and data analysis module for archiving and future model training purposes resulting in an uploaded signed contract, and managing future amendments, expiration reminders, and termination for breach provisions for said uploaded contracted using a contract lifecycle management module.

In another embodiment, a method for contract analysis and generation comprises processing a file resulting in a processed file, parsing keywords from the processed file resulting in a plurality of parsed keywords, generating a question list based on the parsed keywords, generating a contract template, obtaining a filled in question list by engaging in offline negotiation using said question list and said contract template, uploading the filled in question list, and generating a desired contract with a single click.

In another embodiment, a method for contract analysis and generation comprises processing a file resulting in a processed file, parsing keywords from the processed file resulting in a plurality of parsed keywords, generating a question list based on the parsed keywords, generating a contract template, obtaining a filled in question list by engaging in offline negotiation using said question list and said contract template, uploading the filled in question list, and generating a desired contract with a single click where, prior to offline negotiation, party information is added to said question list and said contract template.

In another embodiment, a method for contract analysis and generation comprises processing a file resulting in a processed file, parsing keywords from the processed file resulting in a plurality of parsed keywords, generating a question list based on the parsed keywords, generating a contract template, obtaining a filled in question list by engaging in offline negotiation using the question list and the contract template, uploading the filled in question list, and generating a desired contract with a single click where, after the desired contract is generated, the desired contract undergoes an approval and signature process by all relevant parties and then the desired contract is uploaded to a machine learning and data analysis module for archiving and future model training purposes.

In another embodiment, a method for contract analysis and generation comprises processing a file resulting in a processed file, parsing keywords from the processed file resulting in a plurality of parsed keywords, generating a question list based on the parsed keywords, generating a contract template, obtaining a filled in question list by engaging in offline negotiation using the question list and the contract template, uploading the filled in question list, and generating a desired contract with a single click where, after a signed contract is uploaded and archived resulting in an uploaded contract, future amendments, expiration reminders, and termination for breach provisions for said uploaded contracted are managed using a contract lifecycle management module.

### BRIEF DESCRIPTION OF THE DRAWINGS

This invention will be better understood with reference to the following drawings, flowcharts, and figures, which are intended to illustrate specific embodiments within the overall scope of the invention as claimed:

FIG. 1 is a flowchart depicting an overview of the contract analysis and generation process;

FIG. 2 is a flowchart depicting one embodiment of the file reading and analysis process;

FIG. 3 is a flowchart depicting one embodiment of the contract template generation process;

FIG. 4 is a flowchart depicting one embodiment of the contract drafting process;

FIG. 5 is a flowchart depicting one embodiment of the machine learning data analysis module;

FIG. 6 is an overview of one embodiment of the contract analysis and generation system environment;

FIG. 7 shows a section of an example first question list based on example clause 10.1; and

FIG. 8 shows a diagram of one embodiment of a user device configured to perform the contract analysis and generation process.

### DETAILED DESCRIPTION

In the following description, to better understand the aforementioned purposes, features, and advantages of the present invention, numerous specific details are set forth in order to provide a thorough understanding of the claimed subject matter. It should be noted that these details and examples are provided to merely aid in understanding the descriptions, and they do not, in any way, limit the scope of the present invention. The present invention can also be implemented in other modes different from those described herein and the present invention is not limited to the specific embodiments disclosed below.

The present invention further leverages artificial intelligence, natural language processing, and machine learning technology to facilitate the analysis and generation of contracts. The various system applications that leverage artificial intelligence, natural language processing, and machine learning technology may be trained and configured for proper practice of the invention prior to a user or entity beginning the process of contract analysis and generation. Additionally, said various system applications may be further trained and improved as the user or entity managing the contract analysis and generation system processes a plethora of legal contracts and other legal documents ripe for analysis using the system.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including, but not limited to, an object-oriented programming language such as Python, Java, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention. In some embodiments, Microsoft Word and Microsoft Excel add-ins may be utilized during the contract analysis and generation process.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While particular embodiments have been shown and described throughout this application, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation, no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

As used herein, the term “user” may refer to any entity or individual associated with the contract analysis and generation system and method described herein. In some embodiments, a user may be a computing device user, a phone user, a mobile device application user, a customer of an entity or business, a system operator, and/or an employee of an entity (e.g., a business institution).

As used herein the term “user device” may refer to any device that employs a processor and memory and can perform computing functions, such as a personal computer or a mobile device, wherein a mobile device is any mobile communication device, such as a cellular telecommunications device (i.e., a cell phone or mobile phone), a mobile Internet accessing device, or other mobile device. Other types of mobile devices may include laptop computers, tablet computers, wearable devices, cameras, video recorders, audio/video player, radio, global positioning system (GPS) devices, portable digital assistants (PDAs), automated teller machines (ATMs), or any combination of the aforementioned. The device may be used by the user to access the system directly or through an application, online portal, internet browser, virtual private network, cloud server, or other connection channel.

As used herein, the term “entity” may be used to include any organization or collection of users that may interact with the contract analysis and generation system and method described herein. An entity may refer to a business, company, or other organization that either maintains or operates the system or requests use and access of the system.

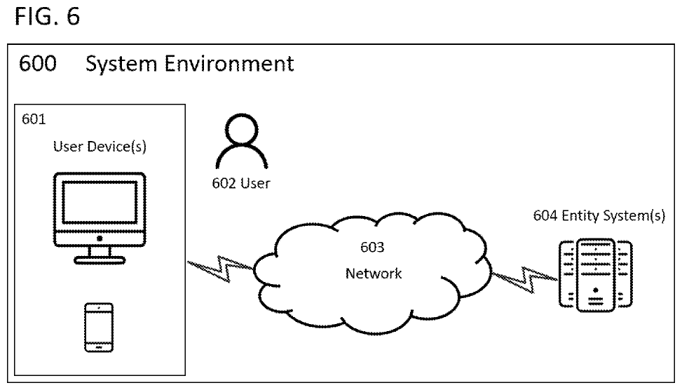

FIG. 6 provides a contract analysis and generation system environment 600, in accordance with one embodiment of the invention. As illustrated in FIG. 6, one or more user device(s) 601 are operatively coupled, via a network 603, to one or more entity system(s) 604. In this way, the user device(s) 601 are configured to send information to and receive information from the entity system(s) 604. In the illustrated embodiment, a plurality of user devices 601 may communicate with the entity system(s) 604 over a network 603.

FIG. 6 illustrates only one example of an embodiment of a computer system 600. It will be appreciated that in other embodiments, one or more of the systems, devices, or servers may be combined into a single system, device, or server, or be made up of multiple systems, devices, or servers. It should be understood that the servers, systems, and devices described herein illustrate one embodiment of a contract analysis and generation method and system. It is further understood that one or more of the servers, systems, and devices can be combined in other embodiments and still function in the same or similar way as the embodiments described herein.

A network 603 may be a system specific distributive network receiving and distributing specific network feeds and identifying specific network associated triggers. The network 603 may also be a global area network (GAN), such as the Internet, a wide area network (WAN), a local area network (LAN), or any other type of network or combination of networks. The network 603 may provide for wireline, wireless, or a combination wireline and wireless communication between devices on the network 603. The network 603 may further comprise a peer-to-peer communication network.

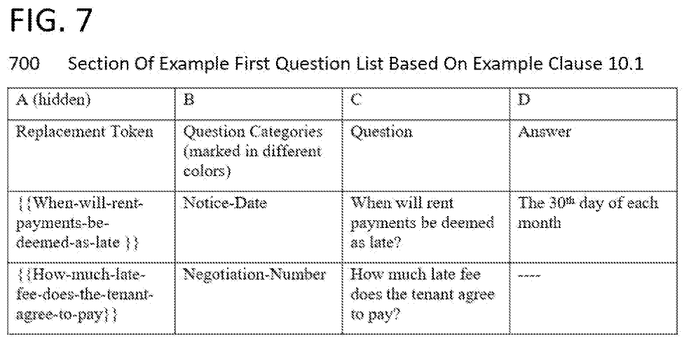

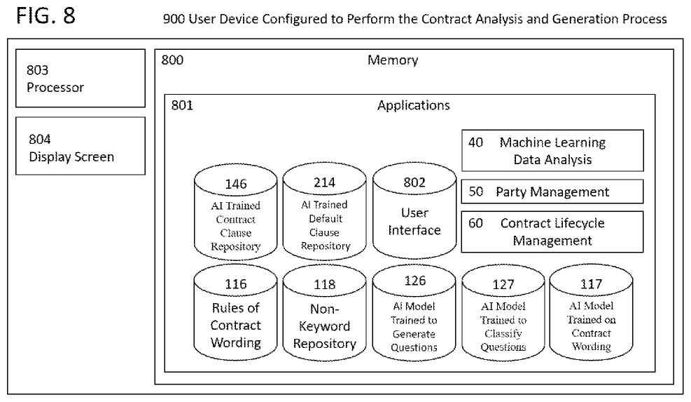

The entity system(s) 604 and user device(s) 601 include data storage and processing capabilities for storing data related to the system environment, but not limited to, data created and/or used by (as shown in FIG. 8) a plurality of system applications 801. As shown in FIG. 8, the various applications of the contract analysis and generation system, and their related data, may be held in a memory 800 of one or more entity system(s) 604 and one or more user device(s) 601. In some embodiments, the user may interact with a contract analysis and generation system through a user interface 802. As shown in FIG. 7, said plurality of system applications 801 include, but are not limited to, a machine learning data analysis module 40, a party management module 50, a contract lifecycle management module 60, a rules of contract wording module 116, an AI model trained on contract wording 117, a non-keyword repository 118, an AI model trained to generate question 126, an AI model trained to classify questions 127, an AI trained contract clause repository 146, and an AI trained default clause repository 214.

The user interface 802 is further configured to perform single click contract generation. The AI trained contract clause repository 146 contains a plurality of contract clauses and is configured to check whether all important clauses are contained within a contract. The AI-trained default clause repository 214 uses an AI-based model trained on questions to determine if questions have default answers and is configured to insert said default answers next to their respective questions in a question list. The rules of contract wording module 116 contains keyword rules specific to properly wording contracts. The AI model trained on contract wording 117 is an AI-based model trained to parse contract terms from a question list. The non-keyword repository 118 is configured to remove keywords parsed from the AI named-entity recognition (NER) that are not considered as variables in a contract from the text on which the system is operating (typically a list of keywords). The AI model trained to generate questions 126 is an AI-based model trained on keywords and questions and is configured to convert sentences containing keywords into questions written in ordinary language. The AI model trained to classify questions 127 is an AI-based model trained on questions and classification categories and is configured to classify questions into various question categories. The machine learning data analysis module 40 is configured to perform the following functions as needed: comparing different templates and different versions of a template, comparing a contract with a contract template, comparing different versions of a contract with one another, and comparing contracts with previously signed contracts which used the same or a similar template. The party management module 50 may include, but is not limited to, enterprise resource planning (ERP) and CRM systems utilized by users and entities of the system, and is configured to insert party information in question lists and contract templates. The party management module 50 may further be communicatively coupled to the memory 800 and the user interface 802. The contract lifecycle management module 60 can be communicatively coupled to the memory 800 and the user interface 802 and configured to facilitate the management of a contract's lifecycle, including, but not limited to, alerting users to the necessity of new contracts, reminding users of upcoming contract expiration dates, and managing amendments made during the execution process of the contract.

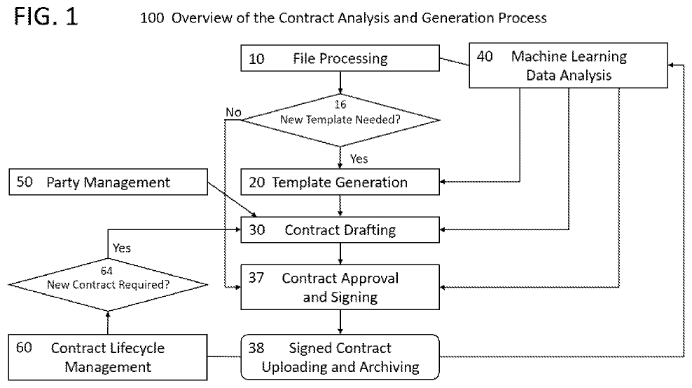

In some embodiments, users and entities may rely on ERP and CRM systems to function as data repositories where said systems may be used to store information and data associated with one or more users, one or more entities, one or more user devices, and/or entity devices as described herein. Said modules may be accessed by (as shown in FIG. 1) the party management module 50 using well-known application programming interface (API) practices. Such ERP and CRM systems may be stored on one or more entity system(s) 604 and/or one or more user device(s) 601.

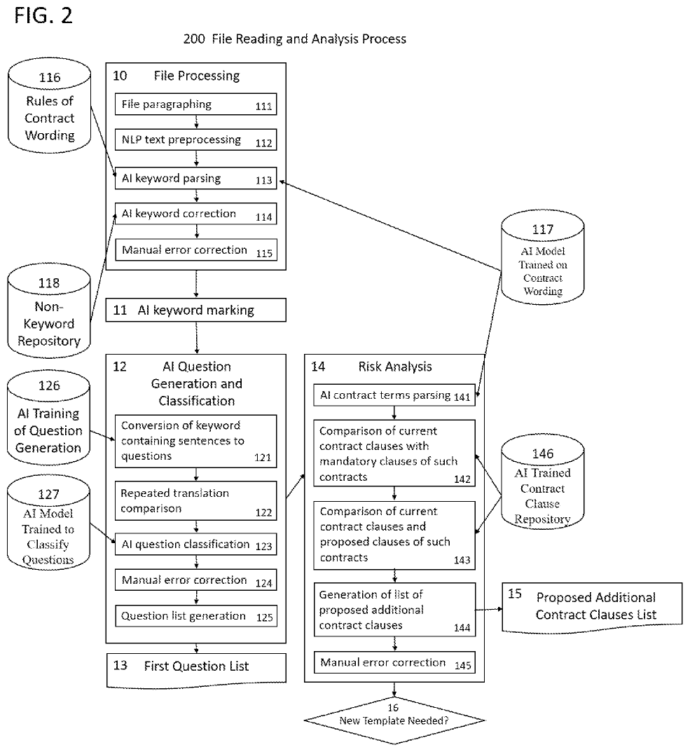

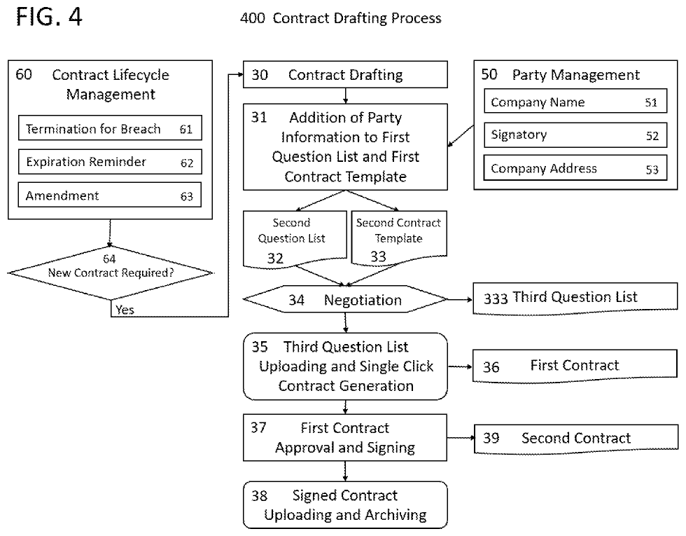

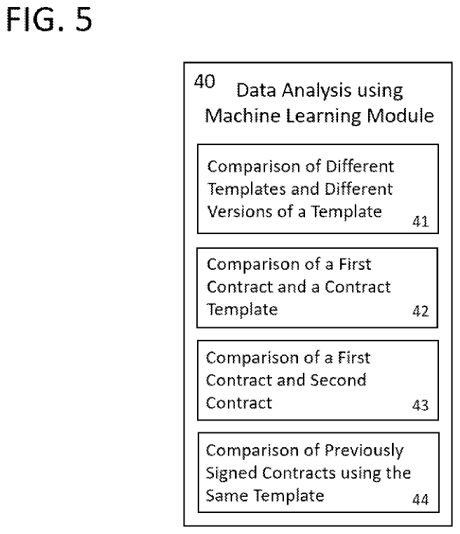

Referring to FIG. 1, an overview of one embodiment of a contract analysis and generation process 100 is shown. First, with the assistance of a plurality of the system's applications 801, file processing 10 occurs, turning user uploaded files with text, typically contracts, into (as shown in FIG. 2) a first question list 13 and a proposed additional contract clauses list 15 (a list of proposed contract clauses recommended after risk analysis step 14). The first question list 13 comprises, without limitation, a spreadsheet containing question classifications, a list of questions, and a plurality of respective answers to the questions. Different question classifications are marked in different colors, such that negotiators may focus solely on the clauses to be negotiated. Next, if the parsed contract clauses and proposed additional contract clauses list 15 are used as a model to generate a contract template (choice “Yes” at decision 16), the process of template generation 300 is triggered. Otherwise, the overall process skips to the step of contract approval and signing 37. Choice “No” at decision 16 may be determined, without limitation, by a user 602 choosing said option through the user interface 602 or by the user 602 or one or more user device(s) 601 or one or more entity system(s) 604 simply not executing the following process up to the step of first contract approval and signing 37 where the process is then resumed. Choice “Yes” at decision 16 may be determined, without limitation, by the user 602 choosing said option through the user interface 602 or by the user 602 or one or more user device(s) 601 or one or more entity system(s) 604 executing the following process. The process of template generation 20 uses a first question list 13 to generate a first contract template 25, a standard contract question list 23, and a standard contract template 24. The standard contract template 24 will be later used during the step of contract drafting 30. The template generation process 300 may utilize a party management module 50 (which may include, but is not limited to, ERP and CRM systems utilized by users and entities of the system) to insert party information into (as shown in FIG. 4) the standard question list 23 and the standard contract template 24, effectively generating a second question list with party information 32 and a second contract template with party information 33. Next, offline negotiation 34 occurs. There, various users and entities participating in business negotiations utilize the second question list 32 and the second contract template 33 to efficiently fill in the answer columns in the second question list 32 resulting in a completed second question list. This completed second question list 32 is herein referred to as a third question list 333. In some embodiments, offline contract negotiations may be guided by the machine learning data analysis module 40. Once negotiations are complete and said third question list 333 is then uploaded 35 by a user 602 to one or more entity system(s) 604 or one or more user device(s) 601, a first contract 36 may be generated by a single click. This single click generation greatly reduces the time and effort it traditionally takes to draft a contract where users have to enter answers and clauses one at a time into text editors such as Word or other contract generation systems currently on the market. Next, the step of approval and signature 37 of the first contract 36 by a plurality of parties bound by the contract occurs, resulting in a signed first contract herein referred to as a second contract 39. The second contract 39 is then uploaded and archived 38 to either one or more entity system(s) 604, one or more user device(s) 601, or both. In some embodiments, (as shown in FIG. 5) the second contract 39 can then be compared with the first contract 36 by utilizing a comparison of a first contract and second contract module 43 to confirm that neither contracting party has made any amendment to the contract during the signing process. In some embodiments, after the contract drafting, approval, and signing processes are complete, the second contract 39 enters the (as shown in FIG. 4) contract lifecycle management module 60. Said module's primary purpose, without any limitations, is managing amendments made during the execution process of the contract, reminding users and entities of contract expirations, and dealing with termination for breach. For some contracts, the contract lifecycle management module 60 may require a new contract to be generated, approved, and signed (choice “Yes” at decision 64). For embodiments that do not require this step, the contract analysis and generation process terminates here.

To better describe the basic principles, main features, and advantages of the present contract analysis and generation process and system, a specific embodiment of the invention will be exemplified below. Those skilled in the art shall understand that the present invention is not limited by the below embodiment. The below embodiment and description merely illustrate the principle of the present invention. Various changes and improvements can also be made to the present invention without departing from the spirit and scope of the present invention and shall fall into the scope of the present invention. The protection scope of the present invention is defined by the appended claims and equivalents.

First, a user 602 uploads relevant files containing text, likely contracts, to the user device(s) 601 or the entity system(s) 604 hosting the contract analysis and generation system. Next, referring to FIG. 2, the file reading and analysis process 200 occurs. First, file processing 10 occurs. Here, extracted text is paragraphed 111. The paragraphed text then undergoes NLP text preprocessing 112 paragraph by paragraph and sentence by sentence, including, but not limited to, tokenization and stopword removal, resulting in preprocessed paragraphs. After the step of natural language processing 112, with the assistance of a rules of contract wording 116 module and an AI model trained on contract wording 117, AI keyword parsing 113 occurs on the preprocessed paragraphs. The AI keyword parsing method is to take the existing general name entity recognition (NER) training repository as the prototype and add keyword rules specific to wording contracts 116 and train a model on contract text 117. Keywords include, but are not limited to, date(s), personal name(s), company name(s), product name(s), territories, quantities, definitions, prices, percentages, methods of payment, modes of transportation, applicable laws, and other key contract clauses.

To illustrate the step of file processing 10, take the following paragraph: “10.1 Late Fee. Rent paid after the 30^{th} day of each month will be deemed as late. If rent is not paid by said due date, Tenant agrees to pay a late charge of $100.00.” Once the step of NLP text preprocessing occurs on the above paragraph, the following text is obtained: “10.1”—Ordinal, “tenant”—ORG, “the 30^{th} day of each month”—Date, and “$100.00”—Money.

Keywords searched from an AI NER repository may contain some non-keywords and errors. For example, the number “10.1” is not a keyword. Additionally, the “tenant” is a party, not an “ORG”. This is both an AI error and a non-keyword mistake. Accordingly, a trained non-keyword repository module 118 is then used to remove unnecessary keywords 114. Next, manual error correction 115 occurs, where a user 602 or an entity interacts with a user device to access the system directly or through an application, online portal, internet browser, virtual private network, or other connection channels known in the art, to make any further changes to the text as they see fit. Continuing our example, after the aforementioned steps have been completed, the following text remains: “the 30^{th} day of each month”—Date, and “$100.00”—Money.

Next, the process of AI-driven question generation and classification 12 occurs. First, an AI model trained to generate question 126 is used to convert sentences containing keywords to questions 121 written in ordinary language to form a precursor to the first question list 13. In some embodiments, if a file is an underlined blank template, the system will generate questions according to the positions of the underlines. Next, in some embodiments, the step of repeated translation comparison 122 is used to perform multiple translations of the text between two languages and to compare the similarity between translation results. There, AI-based translation services may be used to perform multiple translations on the text between two languages. The similarity between translation results is then compared. If the similarity is higher than a preset or user-defined threshold, the AI-based translation is selected. However, if the similarity is lower than said preset or user-defined threshold, the user will be notified on a display screen 804 using the user interface 602 to manually read and amend the results. For example, if the original contract is in English, the first question list precursor will be translated from English (EN1) to another language (preferably, but not limited to, a significantly different one such as Chinese (CN1)) and then back to English (EN2). If the similarity of the EN1 translation and the EN2 translation is higher than said preset or user-defined threshold threshold, an AI translation is selected or the EN2 translation is further translated into Chinese (CN2). If the similarity of the CN1 translation and the CN2 translation is higher than said preset or user-defined threshold threshold, an AI translation is selected. Otherwise, the system will notify the user to write questions for first question list 13 manually on the display screen 804 using the user interface 602.

Subsequently, all questions are classified 123 using an AI model trained to classify questions 127. Purely for illustrative purposes, and without limitation, questions may be divided into four categories as follows: starting and ending dates of a contract, party information, clauses to be reviewed by a user or entity (such as how to calculate the exchange rate and which legal provisions should take priority in the event of a disagreement), and clauses to be negotiated (such as price). Classifying questions helps the user or entity focus on key points to discuss during the negotiation process without neglecting other important clauses. After the question classification process, the user may make corrections and adjustments manually as necessary 124. Afterward, the system will generate 125 a first question list 13 in the form of a spreadsheet. The first question list 13 contains a list of questions, the classification of said questions, and a list of answers to said questions. This first question list 13 will later be used to generate contract clauses. Different question classifications are marked in different colors, so that the negotiating parties may focus their efforts on more pivotal clauses ripe for negotiation. By only reading the first question list 13 spreadsheet, a user can obtain all of the initial uploaded file's important information, greatly reducing the workload of reading the full contract text (which may span hundreds or thousands of pages) and allowing for rapid comparison with future contract question lists and rapid sharing of condensed contract information within the entity that uses the system.

If a contract is international (either multilingual or written in a language different from the user or entity's primary language contracts are written in), the first question list 13 will be automatically translated into another language. During this process, a technically complicated contract will be parsed into a first question list 13 which contains answers written in ordinary business language in the user's or entity's target language. The keywords in the original multilingual contract are highlighted. Such simplification and translation efforts greatly improve the efficiency of system users and entities to review the contract, enabling regular business personnel to quickly focus on the contract's core business points during review and negotiations.

Next, the process of risk analysis 14 occurs. First, utilizing an AI model trained on contract wording 117, contract terms are parsed 141 from the first question list 13. The resulting parsed contract terms are then compared with an AI trained contract clause repository 146 to check whether all important clauses are contained within the first question list 13 at this point in the process 143. For example, and without limitation, whether an insurance clause exists in an initial contract file concerning leasing. If such an insurance clause is not found, the system will notify the user with an automatic prompt on the display screen 804 using the user interface 602. Such clauses are divided, without limitation, into two categories: mandatory clauses and proposed clauses. The mandatory and proposed clauses are organized and recommended to the user in the form of a proposed additional contract clauses list 15. Next, using the system or a generic text editor, the user may make manual corrections as necessary to include or exclude individual contract clauses 145.

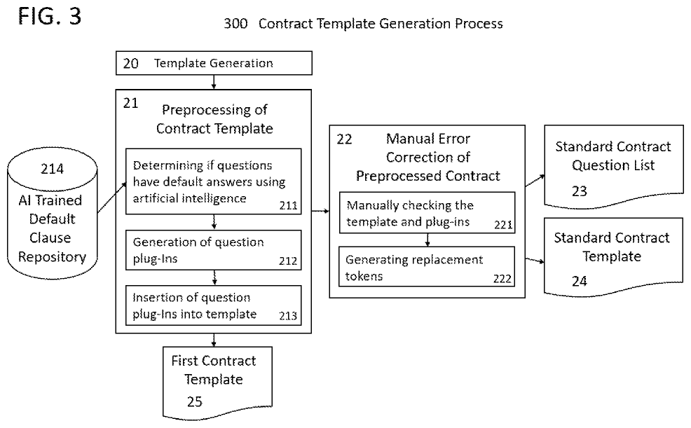

If the first question list 13 is used as the model to generate a contract template (choice “Yes” at decision 16), the (as shown in FIG. 3) template generation process 300 occurs. Choice “No” at decision 16 may be determined, without limitation, by the user 602 choosing said option through the user interface 602 or by the user 602 or one or more user device(s) 601 or one or more entity system(s) 604 simply not executing the following process up to the step of first contract approval and signing 37 where the process is then resumed. Choice “Yes” at decision 16 may be determined, without limitation, by the user 602 choosing said option through the user interface 602 or by the user 602 or one or more user device(s) 601 or one or more entity system(s) 604 executing the following process. A specific embodiment of the template generation process 300 is shown in FIG. 3: First, the preprocessing 21 of the contract template occurs. Here, an AI-trained default clause repository 214 is used to determine if questions from the first question list 13 have default answers using AI 211. For example, a contract clause concerning a starting date generally has no default answer. A “Force Majeure” clause, however, generally does have a default answer. After such a determination, questions contained within the first question list 13 are placed into question plug-ins 212. There, question plug-ins are used to wrap each question in the first question list 13 between specific characters, including, but not limited to, “< >”, “[ ]”, “{ }”, and “( )”. The default answers uncovered in the previous step 211 are also written within the specified characters encompassing questions. Without limitation, answers may be written after the character “=”. For example, “<How much late fee does the tenant agree to pay>” is a question plug-in without a default answer. In contrast, “<When will rent payments be deemed as late=the 30^{th} day of each month>” is a question plug-in with a default answer. The question plug-in is then inserted into the system's template file to generate a first contract template 25. For example, text found within the first contract template 25 may read: “10.1 Late Fee. Rent paid after <When will rent payments be deemed as late=the 30^{th} day of each month> will be deemed as late and if rent is not paid by such due date, Tenant agrees to pay a late charge of <How much late fee does the tenant agree to pay>.”

The completion of the preprocessing of the contract template step 21 is a first contract template 25 which is a text document. Next, users and entities may make manual alterations and corrections 221 as necessary to the first contract template 25 using the system or a generic text editor without interacting with the system. During this manual correction process, users or entities only need to write the questions in “< >” characters and the default answers after the “=” character, which greatly lowers the threshold of learning a new system. After the step of manual correction 221 is complete, the first contract template 25 is uploaded to either one or more user device(s) 601, or one or more entity system(s) 604, or a unique combination of both. The system then converts the question plug-ins into replacement tokens 222, automatically generating a standard contract question list 23 and a set of standard contract templates 24. In this set, the templates are presented in two formats: as a blank template and as a file, generated by the system for post-processing, with substitution tokens. In certain embodiments of the invention which use, but are not limited to, the Jinja2 format, the conversion step of converting the question plug-ins into replacement tokens is as follows: first, searching for question symbol identifies such as “< >” and checking whether a symbol for marking default answers exists, such as “=”. If yes, then the content within the “< >” characters are divided into questions and their respective default answers. Default answers are stored in the answer table in a system database, and the question portion is marked as slag. Said slag is encircled with “{ { } }”, so as to generate replacement tokens in the Jinja2 format, which may be later used for substitution. Those in the art will recognize that such text modifications may be accomplished with a variety of methods presently known in the art. Accordingly, the scope of the prevent invention should not be limited by the examples found herein. For example: “<How much late fee does the tenant agree to pay>” is converted to “{{How-much-late-fee-does-the-tenant-agree-to-pay}}”. Meanwhile, the format of the replacement tokens is also added to the first question list 13.

At this point, three important files are generated for each template. Without limitation, example files are shown as follows:
1. A blank template:
   10.1 Late Fee. Rent paid after ______ will be deemed as late and if rent is not paid by such due date, Tenant agrees to pay a late charge of ______.
2. A template with replacement tokens for filling in answers at a later point:
   10.1 Late Fee. Rent paid after {{When-will-rent-payments-be-deemed-as-late}} will be deemed as late and if rent is not paid within such due date, Tenant agrees to pay a late charge of {{How-much-late-fee-does-the-tenant-agree-to-pay}}.
3. As illustrated in FIG. 7, a section of an example first question list based on example clause 10.1 700.

Next, as shown in FIG. 4, the contract drafting process 400 occurs. First, party information is added 31 to (as shown in FIG. 2) the first question list 13 and the contract template, resulting in a second question list 32 with party information and a second contract template 33 with party information. In some embodiments, this step may utilize the party management module 50 which may include, but is not limited to, ERP and CRM systems utilized by system users and entities to insert party information into the standard question list 23 and the standard contract template 24. Next, the step offline negotiation 34 occurs. There, various users and entities participating in business negotiations utilize the second question list 32 and the second contract template 33 to fill in the answer column of the second question list 32 during the negotiation process. In some embodiments, offline contract negotiations may be guided by the machine learning data analysis module 40. The data provided by the machine learning data analysis module may include, but is not limited to, statistics such as maximums, minimums, averages, and mediums corresponding to predictions about (as shown in FIG. 2) the first question list 13 questions given through AI model analysis based on contract timing and conditions specified by the non-system user party to the contract.

After negotiations 34 have concluded, the now completed second question list 32 with a filled-in answer column is herein referred to as the third question list 333. Once the third question list is uploaded 35 by a user 602 to entity system(s) 604 or user devices 601, a first contract 36 may be generated, using the user interface, by a single click from the user. The user interface performs single click contract generation as follows: once the user clicks on the corresponding button or icon on the user interface, replacement tokens within the third question list 333 are compared with replacement tokens found within a template, and, if the replacement tokens match, the replacement tokens found within the template are substituted with the corresponding answers from the third question list 333. For example, using the question list from FIG. 7, if the replacement token “{{When-will-rent-payments-be-deemed-as-late}}” is matched with an identical replacement token found within a template, the replacement token found within the template is substituted with the corresponding answer from the question list “The 30th day of each month”. The result of this single click contract generation process is a first contract 36. Compared with other contract generation processes and systems, this single click contract generation greatly reduces the time it takes users to draft a contract where said users have to enter answers and clauses one at a time into a text editor such as Word or other contract generation systems currently on the market. This single click generation also reduces the rate of typing errors. As the first contract 36 is in the form of a text document, the contract clauses may be customized according to specific user requirements. In some embodiments, the first contract 36 can be (as shown in FIG. 5) compared with a previously used contract template 42. In this way, the present invention has both the efficiency and accuracy of a contract analysis and generation system and the flexible contract customization capabilities that traditional methods of contract drafting allow for.

Next, the step of approval and signature 37 of the first contract 36 by the contract's parties, results in the second contract 39. The second contract 39 is then uploaded and archived 38 to either the entity system(s) 604, the user device(s) 601, or both. In some embodiments, the second contract 39 can then be compared with the first contract 36 by the comparison of a first contract and second contract module 43 to confirm that neither contracting party has made any amendment to the contract during the signing process. In some embodiments, after the contract drafting and signing process is complete, the second contract 39 enters the contract lifecycle management module 60. Said module's primary purpose, without any limitations, is managing amendments made during the execution process of the contract, reminding users and entities of contract expirations, and dealing with termination for breach. For some contracts, the contract lifecycle management module 60 may require a new contract to be created (choice “Yes” at decision 64). For embodiments that do not require this step, the contract analysis and generation process terminates here.

The advantages of the present invention can be summarized as follows: The process of generating a first question list 13 and classifying questions 12 on the question list represents the primary innovation of the present invention. This process not only uses intelligent reading to parse keywords but also represents a convenient way to generate contracts and guide negotiations using ML at later stages. To realize these functions, contract language-specific AI and ML were created and adopted. The uploading of the final contract question list 35 expedites the contract generation process by enabling single-click contract generation, eliminating the traditional step of entering answers and clauses one at a time into a text editor.

Furthermore, during the process of contract analysis and generation, existing contracts are analyzed using AI when parsing for keywords 113 and generating 125 a question list. As contracts provide the legal framework for conducting business, contracts are typically professionally drafted documents that have their own drafting norms. Published contracts are difficult to acquire, so current research concerning AI analysis of legal contracts is very limited. However, by combining AI model training with contract drafting rules, the present invention improves the accuracy of NLP parsing and can parse a variety of keywords such as personal names, addresses, company names, numbers, dates, key definitions, key clauses, and important laws.

Additionally, during the process of contract analysis and generation, the system notifies the user if required contract clauses are not included 142. For example, if the “Force Majeure” clause is not mentioned in a supply contract, the system will automatically prompt a user to add said clause.

The present invention does not require users to significantly change their contract drafting and software usage habits. In some embodiments, the system may be seamlessly connected with common software such as Microsoft Word and Excel utilizing plug-ins. Common office software formats such as Word, Excel, and PDF are inherently incorporated into the contract analysis and generation process, greatly minimizing the learning curve for users. Compared with the Mailmerge function of Word, the present contract analysis and generation system is convenient to use and can provide vital business information through data analysis. Mailmerge can use spreadsheets to replace keywords with the Mailmerge format in Word documents, but the function requires each keyword to have a format to be changed into Mailmerge, which results in an unnecessarily heavy workload for users at an early stage. Furthermore, when using Mailmerge, data is not automatically stored in a database for potential future data analysis. Compared with the processing mode of other similar “question plug-ins” currently on the market, the present invention has three primary advantages: AI-assisted keyword marking, the generation of question plug-ins for even lengthy and complex questions, and the generation of contract-specific default answers.

In some embodiments, the accuracy of generated questions may be confirmed using a repeated translation-comparison method. The method is easy to implement and has high accuracy. A translated question list is automatically provided for international contracts.

After a contract is generated, its clauses may still be manually adjusted by users. Manual adjustments facilitate contract flexibility while retaining the high efficiency and high accuracy of using a contract analysis and generation process. Differences between the first contract 36 and the contract template used can be quickly discovered through comparison. This allows users to rapidly understand the changes the contract underwent during the generation process.

In the present invention, the contract is parsed into a legal language template and a question list in ordinary business language rather than legal terminology. This separation makes the contract negotiation process smoother. This also separates the work of legal personnel and business personnel to make the process smoother and the responsibilities clearer. AI review of contract clauses allows the legal personnel to more clearly understand whether the contract clauses are comprehensive and achieve the desired contract goal. The question list significantly speeds up the negotiation process, makes discussing the contract's contents easier, and significantly reduces the rate of accidental omissions. Presently, no similar process exists on the market.

Because the contract is effectively parsed into a standard contract question list 23, the system can perform ML data analysis 40 on the answers to the questions contained within various question lists created during the contract analysis and generation process. The results of such analysis can be used for guiding business negotiations and predicting the results of contract executions.

What is claimed is:

1. A method of contract analysis and generation comprising: with a computer system that comprises an AI trained contract clause repository, a non-keyword repository, an AI trained default clause repository, a user interface, a rules of contact wording module, a machine learning data analysis module, an AI model trained to generate questions, an AI model trained to classify questions, and an AI model trained on contract wording:
uploading a file containing text to said computer system;
processing said file, by said computer system, resulting in a processed file;
parsing, by said computer system, a plurality of keywords from said processed file;
generating, by said computer system, a plurality of questions from said plurality of keywords, resulting in a first question list;
classifying, by said computer system, said plurality of questions in said first question list; and
performing risk analysis, by said computer system, on said first question list.

2. The method of claim 1, further comprising:
in response to determining that a first contract template should be generated:
generating, by said computer system, said first contract template modeled after said first question list;
adding, by said computer system, a plurality of party information to said first question list and said first contract template, resulting in a second question list with said plurality of party information and a second contract template with said plurality of party information;
conducting offline negotiations using said second question list and said second contract template, resulting in a third question list;
uploading said third question list to said computer system; and
generating, by said computer system, a first contract based on said third question list and said second contract template with a single click.

3. The method of claim 2, further comprising:
approving and signing of said first contract, by a plurality of parties to said first contract, resulting in a second contract which is signed; and
uploading said second contract to said computer system for archiving and future model training purposes.

4. The method of claim 1, with said computer system also including a contract lifecycle management module and a plurality of contracts, further comprising:
monitoring, by said contract lifecycle management module, a plurality of amendments made to said plurality of contracts;
monitoring, by said contract lifecycle management module, a plurality of expiration dates of said plurality of contracts; and
notifying one or more users, by said user interface, of said plurality of amendments and said plurality of expiration dates.

5. The method of claim 2, with said computer system also including a contract lifecycle management module and a plurality of contracts, further comprising:
monitoring, by said contract lifecycle management module, a plurality of amendments made to said plurality of contracts;
monitoring, by said contract lifecycle management module, a plurality of expiration dates of said plurality of contracts; and
notifying one or more users, by said user interface, of said plurality of amendments and said plurality of expiration dates.

6. The method of claim 3, with said computer system also including a contract lifecycle management module and a plurality of contracts, further comprising:
monitoring, by said contract lifecycle management module, a plurality of amendments made to said plurality of contracts;
monitoring, by said contract lifecycle management module, a plurality of expiration dates of said plurality of contracts; and
notifying one or more users, by said user interface, of said plurality of amendments and said plurality of expiration dates.

7. A contract analysis and generation system comprising:
a processor;
a non-transitory computer readable medium connected to the processor;
a set of instructions on the computer readable medium that are executable by the processor, including:
a user interface;
an AI trained contract clause repository;
a default clause repository;
a non-keyword repository;
a rules of contract wording module;
a machine learning data analysis module;
an AI model trained to generate questions;
an AI model trained to classify questions; and
an AI model trained on contract wording.

8. The system of claim 7 further comprising:
a contract lifecycle management module in the form of a set of instructions on the computer readable medium that are executable by the processor.

9. A non-transitory computer-readable medium having stored thereon a set of instructions that are executable by a processor of a computer system to carry out a method of analyzing and generating a contract comprising:
uploading a file containing text to said computer system;
processing said file, by said computer system, resulting in a processed file;
parsing, by said computer system, a plurality of keywords from said processed file;
generating, by said computer system, a plurality of questions from said plurality of keywords, resulting in a first question list;
classifying, by said computer system, said plurality of questions in said first question list;
performing risk analysis, by said computer system, on said first question list;
in response to determining that a first contract template should be generated:
generating, by said computer system, said first contract template modeled after said first question list;
adding, by said computer system, a plurality of party information to said first question list and said first contract template, resulting in a second question list with said plurality of party information and a second contract template with said plurality of party information;
conducting offline negotiations using said second question list and said second contract template, resulting in a third question list;
uploading said third question list to said computer system;
generating, by said computer system, a first contract based on said third question list and said second contract template with a single click;
approving and signing of said first contract, by a plurality of parties to said first contract, resulting in a second contract which is signed; and
uploading said second contract to said computer system for archiving and future model training purposes.
